(19) United States
(12) Patent Application Publication
(10) Pub. No.: US 2023/0325792 A1
(43) Pub. Date: Oct. 12, 2023

(54) Method and a system to decrease deforestation and clearcutting by issuing a green crypto utility token adding a new layer of non-fungible digital value

(71) Applicant: Everforest OÜ, Viljandi (EE)

(72) Inventor: Siim Timpson, Viljandi (EE)

(21) Appl. No.: 18/297,690

(22) Filed: Apr. 10, 2023

Related U.S. Application Data
(60) Provisional application No. 63/328,879, filed on Apr. 8, 2022.

(51) Int. Cl. G06Q 20/06; G06Q 10/30

(52) U.S. Cl. CPC G06Q 20/0652; G06Q 10/30; G06Q 2220/00

(57) ABSTRACT

A cryptocurrency based platform for supporting sustainable forest management is provided. The platform comprises a multitude of non-fungible tokens (NFTs), wherein each NFT corresponds to an individual or shared forest plot, said forest plot being subject to a binding agreement executed in exchange of issuing the NFT. Each issued NFT has a defined environmental value determined by at least a carbon sink value of the forest plot. Each issued NFT corresponds to a tradeable digital or physical NFT certificate having a scannable code that comprises information of the forest plot and the environmental value of the NFT.

### PRIORITY

This application claim priority to U.S. Provisional application No. 63/328,879 filed on Apr. 8, 2022.

### FIELD OF INVENTION

This disclosure relates to forest habitat restoration, more specifically to the field of method and system for adding value to the forestry by issuing a crypto utility token which is convertible to non-fungible token (NFT)—also known as non-fungible digital asset. A unique method and system to slow down human induced climate change by providing incentives for restoration and retaining forests and thus enabling forest vegetation to release more oxygen and to absorb carbon dioxide is disclosed.

### BACKGROUND OF INVENTION AND A PROBLEM TO BE SOLVED

The climate of the planet Earth has changed throughout the history. However, since the middle of 20^{th} century the warming of the temperature has proceeded at a rate that has never happened before. This warming of the atmosphere has been connected to increased amounts of so-called greenhouse gases, e.g., carbon dioxide, that due to their heat trapping nature prevent transfer of heat through the atmosphere. Human activities have undeniably affected the constantly increasing carbon dioxide concentrations in the atmosphere. According to some studies carbon dioxide from human activity is increasing more than 250 times faster than it did from natural sources after the last ice age. As a result of the increased amounts of greenhouse gases the average temperature has risen about one Celsius degree since late 19^{th} century. Most of this warming occurred during the last 40 years, and the last seven years have been the warmest in the history of the planet.

The cause of increased carbon dioxide is largely related to human activities including among others burning fossil fuels and deforestation. Fossil fuels, as well as forest vegetation are the main carbon binding sources in the planet and by burning the fuels and cutting down the forest human beings are releasing the carbon dioxide into the atmosphere in a speed never seen before. The increasing temperatures due to increased greenhouse gas emissions cause the oceans to warm, which leads to melting of the glaciers everywhere around the world which then causes the sea level to rise resulting eventually water to cover many areas that are currently used as agricultural production and cites that are currently vastly inhabited.

In order to prevent or at least slow down this devastating development, mankind has to find other ways to produce energy than by burning fossil fuels and the deforestation has to be minimized or stopped in order to keep the planet for next generations.

This disclosure concentrates on ways to provide incentives to retain forests. The role of forests in climate change is very important: about 25% of global greenhouse gas emissions come from land sector, and about half of these emissions originate from deforestation and forest degradation. Approximately 2.6 billion tons of carbon dioxide is absorbed globally by forests every year, which is nearly one-third of the carbon dioxide released from burning fossil fuels. Thus, stopping the loss and degradation of forest ecosystems and promoting their restoration have the potential to mitigate over one-third of the emissions released by current activities of burning fossil fuels and to meet the objectives of the Paris Climate Accords (also known as Paris Agreement) by the year of 2030.

In addition to the fact that deforestation destroys the carbon sinks that the forest vegetation represents, the deforestation also has other detrimental effects. Forests represent a critical controlling factor in the hydrological cycle on the planet Earth, forest vegetation is the source of oxygen that we breath. Moreover, forests carry many sociological and psychological values that are not measurable by numbers.

In order to maintain an effective carbon sink it is essential to increase timber growth rate over the deforestation rates. Thus, the solution has to include decreasing deforestation rates, increasing timber growth rate and replanting forests.

With the advances of modern information technology, there are solutions provided to address, for example replanting forests by means of using crypto tokens.

WO2019094828 discloses generally digital crypto asset generation where computer-based systems and methods for generating and distributing crypto assets are provided. In one disclosed embodiments crypto assets are generated and distributed as part of an independent ecosystem to facilitate deployment of assets in the economy to reduce greenhouse gas emission and mitigate climate change. WO2020198409 discloses secure token-based exchange of pollution credits for the reduction of worldwide pollution. In this publication a computing device may receive carbon emission acquisition data indicative of an allowance of carbon emissions. The computing device may generate token data based on the received carbon emissions acquisition data, wherein the token data is associated with a portion of the allowance of carbon emissions and includes a use indicator and ownership indicator. US20200410590 discloses development of a blockchain of immutable, transparent and/or an instantly or near instantly (or real-time) retrievable financial transaction management system to facilitate the evaluation and/or resulting payout and/or assessment of fixed or variable premium or coupon or other forms of credit or debt-transactions associated with an event or performance or warranty or parameter in an environmental or energy or nature-based event or performance of associated infrastructure or insurance or warranty management system.

Also, some crypto projects such as SingleEarth, ForestCoin, Treerise offer various range of crypto tokens, nature-backed digital assets, tree planting services and other similar activities. However, even if these existing crypto projects provide some means for individuals to support activities for creating carbon sinks, these projects do not provide a sustainable and controllable solution for forest management avoiding and/or preventing clearcut the forests. The currently existing crypto projects concentrate on planting single trees and issuing a non-fungible token for each tree planted or mediate services such as EU quotes. None of the currently available crypto projects provide any live indicators or provide personalized information of the physical nature of the forest.

Accordingly, there is a need to supplement and improve the currently existing crypto projects to address a larger picture, where the projects support whole management of a forest and allows the participants of the project to have real time information of an actual forest corresponding to a digital NFT certificate.

### SUMMARY OF THE INVENTION

Accordingly, it is an object of this invention to provide a method and system to address the flaws in currently existing art.

A method and a system are provided here for using cryptocurrency to provide a personal and unique digital NFT certificate, which shows in real time how much added value in terms of bound carbon dioxide and released oxygen an individual contribution brings to the nature. A method and system are provided to automatically monitor the forest health and to provide best management strategies for each forest plot in question to increase timber growth for increasing carbon sink, increase of oxygen production and decrease carbon dioxide emissions.

It is an object of this invention to provide a method and a system based on cryptocurrency, where each unique NFT acquired by predetermined amount of utility tokens corresponds to an exact individual forest location, and a NFT's digital certificate based on QR code is linked to the server and by scanning the code provides information of the unique location and physical state of the actual forest. The individual NFT digital certificate may have a real time updating information such as amount of oxygen produced or carbon dioxide bound by the exact forest location in a certain time period, which could for example be the time period passed since creating the NFT, or any other chosen time period. The digital NFT certificate may correspond to a physical collectible and presentable card i.e. physical copy of digital NFT certificate with individual digital certificate based on QR code. The digital NFT certificate and corresponding physical card have an ‘environmental value’ derived on the information of the actual forest plot. For example, the environmental value of a digital NFT certificate or the physical card corresponding to an NFT created one day ago and corresponding to a slow growing forest plot of 10 acres may have an environmental value lower than a digital NFT certificate or the physical card corresponding to an NFT created one year ago and corresponding to similarly slow growing plot of 10 acres. On the other hand, a digital NFT certificate or the physical card corresponding to an NFT created one year ago and corresponding to a slow growing forest plot of 100 acres may have a higher environmental value than the abovementioned NFT-certificates or cards. This is meant to be simply an example of what is meant by ‘environmental value’ of the NFT digital certificates or collectible cards and other factors, such as geographical location, climate type, age of the forest and so on are relevant in the determining the environmental value.

It is an object of this invention to provide method and system based on cryptocurrency to support whole management of a forest in sustainable way without a need of clearcutting. In a preferred embodiment the participating forest locations are owned by the startup company and a prerequisite for creating an NFT corresponding to a forest location, a binding contract is executed for a promise that the forest owner (in this case the startup company) is not allowed to clear cut the forest plot corresponding to the NFT to be created. In an alternative embodiment forest plots owned by third parties may be included into the crypto project with similar contracts binding the third-party owners from clearcutting.

A method and a system are provided here using cryptocurrency to enable retainment and restoration of forests.

A method and system are provided using the AI technology to monitor the forest health and to provide best management strategies for each forest plot in question to increase timber growth for increasing carbon sink, increase of oxygen production and decrease carbon dioxide emissions and to update the NFT digital certificates in real time to include the information related to the forest location corresponding to the digital NFT certificate.

An object of the invention is to provide a digital crypto asset issued for the purpose of supporting sustainable management of a forest and preventing clearcutting of the forest, wherein the crypto asset combines a utility token and non-fungible token (NFT) backed up by a combination of at least one server including communicatively connected personal devices and a startup company's server that provides the live indicators, wherein each participant within the network maintains, approves, and updates new entries. Each NFT corresponds to a forest area subject to a non clearcut contract and includes information of carbon sink value of the exact location and an environmental value of the NFT depends at least on the time period the forest has not been clearcut.

An object of the invention is to provide a blockchain marketplace exchange system for mitigating climate change by providing an incentive to keep forest areas free from clearcutting, comprising a binding contract subject to promise of not clearcutting a specific forest area, and virtual forest plot corresponding to unique location of a real forest, wherein the tokens include information about the status of the forest in terms of carbon sink value, and the environmental value of approved or transferred tokens depend on at least the time the forest area is kept free of clearcutting. The system may additionally include alternative tradeable and transferable digital NFT certificates corresponding to forest related art backed up by the real forest plot subject to no clearcut agreement. The digital NFT certificates may be also provided as physical presentable and collectible cards.

An object of the invention is to provide a platform based on digital crypto asset NFTs corresponding to a unique forest plot contracted not to be clearcut for as long as the crypto asset NFT exist or as long as the contract defines. An individual, unique NFT digital certificate issued for each forest location corresponds to a physical and presentable card i.e. the copy of NFT digital certificate (in the form of printout), having at least a scannable code (QR or any similar), which allows by scanning the code access to information of the actual forest that corresponds with the NFT. Live indicators are connected to the startup company's server to follow the unique part of the forest and the information comprises at least the coordinates and area of the forest, carbon sink value of the forest. The information may comprise also further description of the forest and natural resources within the forest, e.g. description of water reservoirs in the forest area, description of the type of the forest, e.g. coniferous forest and so on. Each digital NFT certificate and/or physical and presentable card has an environmental value based on the time period of the corresponding forest having been not clearcut and the carbon sink value of the forest. In an alternative embodiment, the method may additionally include tradable NFTs corresponding to forest related artwork and the NFTs corresponding also to a forest area subject to a contract not to be clearcut, wherein the NFTs include agreement of author of the artwork transferring any copyrights of the artwork.

An object of the invention is to provide a platform for holistic management system of a forest and digital means to support and participate to forest management. The system comprises tradable and transferable non-fungible tokens (NFTs) acquired by predetermined amount of utility tokens, the non-fungible tokens being issued in exchange of a binding contract for a promise of the forest owner not to clearcut a specific forest area corresponding to the NFT. The tokens have an environmental value, wherein the environmental value depends on at least the time the forest area is kept free of clearcutting, and wherein the NFT corresponds to the geographical location of the forest area including information about the status of the forest in terms of carbon sink value and other indicators of the wellbeing of the forest, and wherein the information is capable of being updated, measured and evaluated in a computerized system. In one alternative embodiment the management system may additionally include alternative tradeable and transferable NFTs corresponding to forest related art, wherein the alternative NFTs are backed up by a real forest plot subject to no clearcut agreement, and wherein authors of the alternative NFTs transfer their intellectual property rights along with the alternative NFT such that a buyer of the alternative NFT also acquired the intellectual property rights for the art connected to the alternative NFT.

### BRIEF DESCRIPTION OF THE FIGURES

FIG. 1 upper part illustrates the underlying structure of the business method provided here. Lower part illustrates the structure of presentable digital certificate.

FIG. 2 illustrates the basic relationship and flow of the utility tokens between the company (startup) and the investors, and use of the tokes in the crypto project.

FIG. 3 illustrates NFT market and early access to the limited Forestry NFT collection.

FIG. 4. Illustrates an alternative embodiment where certified partners i.e., other forest owners join the program.

FIG. 5 illustrates use of utility token to tree planting.

FIG. 6 illustrates local new NFT market.

FIG. 7 illustrates transfer of Intellectual property rights in the project.

FIG. 8 illustrates the server communication process in the project.

FIG. 9 illustrates peer to peer network i.e., decentralized network blockchain communication process.

FIG. 10 illustrates technical process for the token purchase.

FIG. 11 illustrates digital forestry NFT physical card as collectable for collection.

FIG. 12 is a generic illustration of input and output information to and from the artificial intelligence. The input information may include among others information provided by experts e.g., from universities.

### DETAILED DESCRIPTION OF THE INVENTION

### Definitions

Cryptocurrency (crypto) is a digital virtual currency that is secured by cryptography, which is nearly impossible to counterfeit or double-spend. Cryptography is the practice of ensuring secure communication, especially when third parties are involved. The biggest difference with the monetary system is that cryptocurrency is generally not issued by a central authority, such as a country's national bank and makes use of blockchain technology. Blockchain is a system of recording information in a way that makes it difficult or impossible to change, hack or cheat the system. A blockchain is essentially a digital ledger of transactions that is duplicated and distributed across the entire network of computer systems on the blockchain. Each block in the chain contains a number of transactions, and every time a new transaction occurs on the blockchain, a record of that transaction is added to every participant's ledger. The decentralized database managed by multiple participants is known as Distributed Ledger Technology (DLT). Blockchain is a type of DLT in which transactions are recorded with an immutable cryptographic signature called a hash. This means if one block in one chain was changed, it would be immediately apparent it had been tampered with. If hackers wanted to corrupt a blockchain system, they would have to change every block in the chain, across all of the distributed versions of the chain.

Cryptocurrency tokens are part of cryptocurrency. The tokenization is a process of creating tokens as a medium data, often replacing highly sensitive data with algorithmically generated numbers and letters called tokens. Therefore, tokenization can be considered as a process of turning a meaningful piece of data, such as an account number, into a random string of characters called a token that has no meaningful value if breached. Tokens serve as reference to the original data but cannot be used to guess those values.

Non fungible tokens (NFTs) are non-interchangeable unit of data stored on a blockchain. Because each token is uniquely identifiable, NFTs differ from previously described blockchain. NFT can be associated with a particular digital or physical asset (such as a file or a physical object) and a license to use the asset for a specified purpose. The extralegal nature of NFT trading usually results in an informal exchange of ownership over the asset that has no legal basis for enforcement. NFTs function like cryptographic tokens, but, unlike cryptocurrencies such as Bitcoin (BTC) or Ethereum (ETH), NFTs are not mutually interchangeable, therefore not fungible. While for example all Bitcoins are equal, each NFT may represent a different underlying asset and thus may have a different value. NFTs are created when blockchains string records of cryptographic hash, a set of characters identifying a set of data, onto previous records therefore creating a chain of identifiable data blocks. This cryptographic transaction process ensures the authentication of each digital file by providing a digital signature that is used to track NFT ownership.

Startup company as used here, means a company that in the preferable embodiment owns the forest plots corresponding to the created NFTs. A prerequisite for each created NFT is a no clearcut agreement that prevents the startup company to clearcut the forest plot as long as the NFT exists or for a certain period of time. Under the no clearcut contract, the startup company is solely responsible of managing the forest plot. In certain other embodiments the forest plots may be owned by third parties who then will be under a no clear-cut contract executed before the NFT was created.

Binding no clearcut contract as used here means a contract or an agreement that may be in a form of an electronic smart contract or in any other enforceable form, which contract is executed/validated before an NFT is created. The contract gives a promise of no clear cut of the forest plot that corresponds to the NFT and binds the party owning the forest plot not to clear cut the forest.

By forest plot, it is meant an individual area of forest that corresponds to the NFTs acquired by a project participant. One cadastral unit of land (forest) may include one personal plot or multiple forest plots. There may for example be a one acre forest area owned by the startup company and the area is divided into 50 individual forest plots each corresponding to NFTs and depending on the amount of investment one participant may have digital NFT certificate(s) corresponding to one or more of the plots. This enables an individual with only small investment to be capable of participating. The digital NFT certificates will show the location of the individual forest plot in the cadastral unit and information of either the individual forest plot or of the cadastral unit. In an alternative embodiment the full cadastral unit may be shared with different participants and they own for example each 1/50 of the unit. The digital NFT certificates of these participants may show the very same information for the plots because they are co-owners of the full cadastral unit.

Aspects of the invention are implemented on one or more computing devices (computers). For example, a computer-implemented token manager or other controller can manage the issuance, burning, buying, selling and exchange process of crypto assets or any other processes. In an example, a token manager can be implemented in software, hardware, firmware or any combination thereof on one or more computing devices. Such computing devices can include a device having at least one processor and memory. For example, a computing device can be a workstation, mobile device (e.g., a mobile phone, personal digital assistant, tablet or laptop), computer, server, computer cluster, server farm, game console, set-top box, kiosk, embedded system or other device having at least one processor and memory. A computing device can also be coupled to one or more networks. Networks can include, but are not limited to, wired or wireless networks, local area networks, medium-area networks, or wide-area networks like the Internet. Embodiments of the present invention may be software executed by a processor, firmware, hardware or any combination thereof in a computing device. Digital crypto asset generation and distribution process is implemented on a blockchain across multiple computing devices over a computer network. Multiple computing devices are coupled over one or more computer networks to support blockchain transactions and proof of stake as described herein. Digital wallets may be used to handle transfers or receipts of crypto assets. Multiple computing devices may be coupled through wired or wireless connections to the one or more computer networks. Applications and/or browsers may be used at the multiple computing devices to access and carry out the operations and functions described herein.

In order to address the problems described in the background of the invention the starting point of the invention is using crypto utility tokens which can be converted to non-fungible tokens (NFTs). Furthermore, the utility tokens and non-fungible tokens (also called a non-fungible digital assets) are tradable and/or exchangeable.

To be clear, the non-fungible tokens (NFTs) that are created can be considered as digital forestry assets, such as but not limited to: non-fungible land with personalized indicators (forest growth, age, carbon dioxide, oxygen etc.). In some embodiment the digital forestry assets may comprise forest art (paintings, sounds, photos, movies), forest music, other events and activities that can be presented as NFTs.

Furthermore, science research and cooperation with international universities is incorporated into the method and system to find the most efficient way to grow the forests and use the green forest management including artificial intelligence (AI) predictions for sustainable oxygen release and carbon dioxide absorption. By combining input of aerial information, land information, weather information, past forest management plans and other information that is available in a published or live format, AI can provide the best possible way for the forestry management and highlights the special need for actions, including but not limited to the exact region, time, volume, consistency etc. In a preferred embodiment the forest locations subject to the crypto assets and the underlying no clearcut agreement are owned by the startup company. However, in some alternative embodiments the forest plots may be owned by a third party and in such case, there could be a monitoring system to decide if the forest plots are managed sustainably as agreed. If the third party manages the forest plots as agreed, the startup company provides physical certificate to the company or individual. The certificate proves the green forest management and nature conservation.

The invention is now described in more details with reference to the figures appended here.

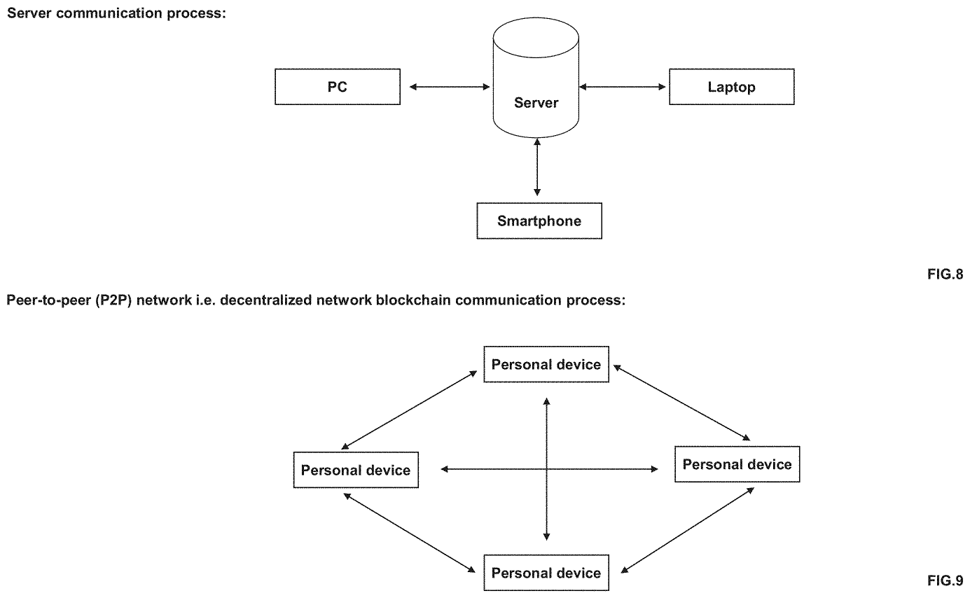

FIG. 9 illustrates decentralized network blockchain communication process. Blockchain is a record of transactions in a ledger or database that is distributed across many participants in a network. This ledger contains records of transactions made in the network. A transaction is the transfer of a currency or a certain amount of money from one user to another in the network. This transaction is cryptographically hashed and recorded in the ledger from a certain node in the network. This node sends transaction to other nodes in the network/broadcasts the transaction to the network. The other nodes receive this transaction, verify the transaction using a standard verification method, and then add the transaction to their ledger. Nodes in the network listen to new transactions broadcast or emitted in the network, then perform the work of adding the transaction to their ledgers. Therefore, each node in the network possesses or has a copy of the ledger. Each blockchain initially starts with a genesis block that the creator adds and is broadcast to the network and has also a cryptographic hash, which serves as a unique identifier in the network—no two blocks can have the same hash. When a block is verified by the nodes and set to be added to the network, this block has a pointer that points to the hash of the last block in the network. This way, any new block being consolidated to the network points to the immediate latest block. This is how the “chain” in the blockchain is formed.

Due to its great flexibility the method and system described here uses Ethereum blockchain with digital currency called Ether. Just like a generic blockchain, transactions are stored in a ledger. Whereas many blockchain platforms only support transferring currencies, Ethereum enables to transfer any data through the blockchain and pay the price with Ethereum blockchain and use of such other blockchains would still fall under the scope of this invention.

The Ethereum blockchain facilitates ETH transactions and every transaction is verified by the nodes in the network and the transactions are added to the blocks in the blockchain. There is an activity called mining (also known as proof of work), which entails working for an Ether. This work involves solving a hard computation by trial and error. This can be done by any node in the network. A node that successfully solves the computation is awarded a certain amount of ETH. The difficulty of the work increases as more transactions are mined. Whenever a transaction is initiated in the Ethereum blockchain, the transaction is mined by a mining node in the network. The sender of the transaction must agree to pay a certain amount of ETH to the node that will mine the transaction. This is called the gas price.

The alternative is proof of stake which is the preferred embodiment and which is a green alternative to proof of work in the future. Unlike proof-of-work, validators don't need to use significant amounts of computational power because they're selected at random and aren't competing. They don't need to mine blocks; they just need to create blocks when chosen and validate proposed blocks when they're not. This validation is known as attesting. Trustworthy device-level attestations permit nodes in a blockchain network to provide truthful evidence regarding their current configuration, operational state, keying material and other system attributes. Validators get rewards for proposing new blocks and for attesting to ones they have seen.

Ethereum has smart contracts contain code that is executed in the Ethereum blockchain. Smart contracts are written in the Solidity language and compiled into an application binary interface (ABI) code. This ABI code is deployed to the Ethereum blockchain. The smart contract takes the externally owned address of the sender plus the nonce (number once) mixed in to form its address in the Ethereum blockchain. Smart contracts enable us to create “digital contracts”. These “digital contracts”, just like contracts in the real world, allow transactions to be set up by two or more parties in the Ethereum blockchain. A smart contract is a type of account in Ethereum. This means it is not controlled by a user and they can send transactions in the blockchain.

Ethereum Virtual Machine (EVM) is a virtual machine in which the compiled Solidity ABI code is run. These smart contracts in Ethereum have become a world standard in creating several tokens. These standards came to be known as Ethereum Request for Comment (ERC) standards. Ethereum has many standards—for example: ERC-20 and ERC-721. Here, ERC-20 is used for creating utility tokens while ERC-721 is used to develop non-fungible tokens (NFTs) both which are very important in our method and system. ERC20 defines a set of rules that apply to all token that choose the ERC-20 standard. ERC-20 tokens can be sent and received. They are fungible tokens, meaning their value is the same everywhere in the blockchain.

Now a technical overview is provided of the three phases of how to create a method and system to decrease deforestation and clearcutting by issuing a green crypto token that is convertible to non-fungible digital asset:

### Phase 1: Creating An ERC-20 Token and Writing a Crypto Currency Whitepaper

We use our EverForest crypto token using the ERC 20 standard. The preferred token name is FORE and symbol EVF.

The token is created with verified smart contract that is capable of executing automatic exchanges of anything of value once preset conditions have been satisfied. In the smart contract code, the balance of the owner is verified to be high enough and whether the owner is approved to send the amount of tokens to the buyer. The transfer is made by subtracting the number of tokens from the owner's balance and allowed balance. Then, the number of tokens is added to the buyer's balance. The transfer event is emitted.

The purpose of the whitepaper is to promote a certain product, service, technology, or methodology, and to influence current and prospective customers' or investors' decisions. While brochures and other marketing materials might be flashy and include obvious sales pitches, a whitepaper is intended to provide persuasive and factual/technical evidence that a particular offering is a superior method of solving a problem or challenge.

After the token is created the whitepaper will be published to explain important information related to the ICO (initial coin offering), including information such as: the purpose of the project, the need of the project, how much investments are needed, how many tokens the founders will keep, which currencies will be accepted, how long the ICO campaign will run and so on. An alternative to ICO is IDO which refers to the launching of a cryptocurrency on a decentralized exchange (DEX). In this case many steps/phases may be automated or coordinated by the decentralized exchange (DEX).

### Phase 2: Launching An ICO or IDO

An initial coin offering (ICO) is the cryptocurrency industry's equivalent to an initial public offering (IPO). Funds to complete the project, certification and development is sought. Interested investors can buy into an initial coin offering to receive the cryptocurrency utility token(s). An alternative embodiment would be IDO. In an IDO, a blockchain project makes a coin's first public debut on a decentralized exchange (DEX) in order to raise funding from retail investors.

### Phase 3: Creating Non-Fungible Tokens (NFTs)

Each blockchain comes with a different NFT token standard which determines which wallet will be compatible. Here, Ethereum NFT token standard is ETH-721. With ETH-721, we can sign up a personal crypto wallet, preferably MetaMask wallet, but other wallets can be used also.

OpenSea marketplace or any similar is used to create NFTs on Ethereum without cost due to so called lazy minting system. Lazy minting allows creation of NFT and put it up for sale without it actually being written to the blockchain, thus avoiding any fees. When someone actually buys the NFT, the fees for writing the NFT to the blockchain will be bundled with the fees to transfer it to the buyer. That enables to avoid the situation where minting fees would be paid without ever selling the NFT.

Below the business method and the system according to this invention is described in details:

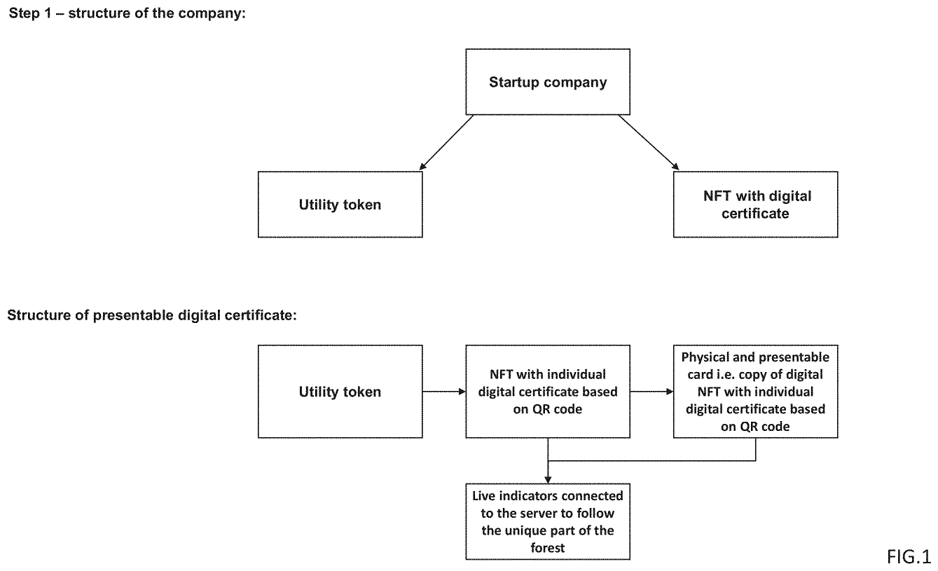

Step 1: The business method and system have 3 key components: startup company, utility token and digital NFT certificate (FIG. 1 upper part).

To proceed, there is a need for a server that is combined with peer-to peer (P2P) network to support the next steps. The first part is important to handle the website and communication with the client i.e., also known as the traditional architecture of the World Wide Web uses a server network (FIG. 8), including the personal devices like PC, laptop and smartphone which are all communicatively connected to the server. The server keeps all the required information in one place so that it is easy to update, due to the server being a centralized database controlled by a number of administrators with permissions.

In the distributed network of blockchain architecture (FIG. 9), each participant within the network maintains, approves, and updates new entries. For example, any personal device could be considered as a server. The system is controlled not only by separate individuals, but by everyone within the blockchain network. Each member ensures that all records and procedures are in order, which results in data validity and security. Thus, parties that do not necessarily trust each other are able to reach a common consensus. That network consists of many computers, but in a way that the data cannot be altered without the consensus of the whole network (each separate computer).

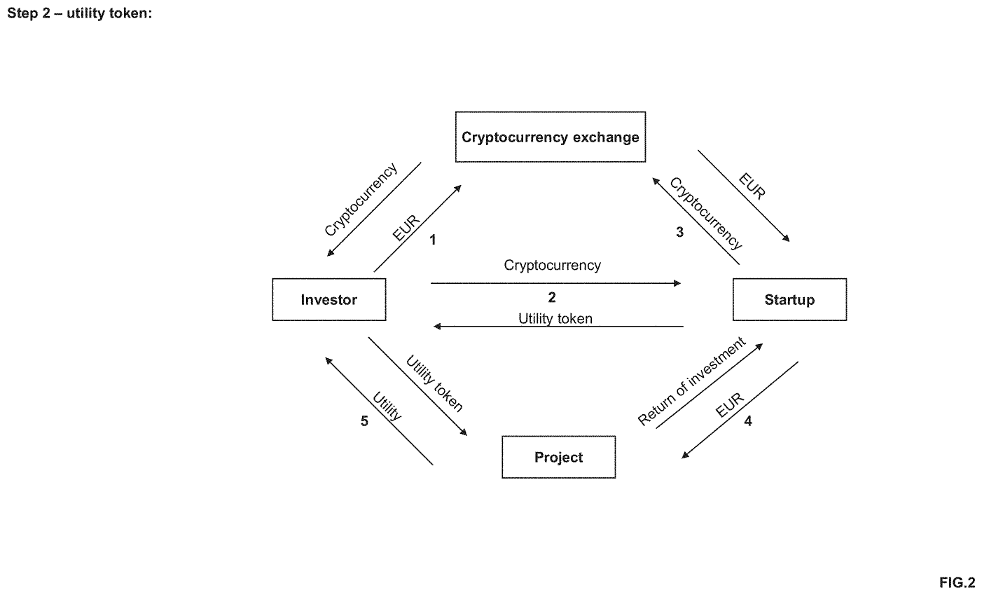

Step 2: Utility token (FIG. 2). This step is crucial for the method and system. In this step, utility tokens listed as ICO or IDO are sold to a number of investors. The investor needs to have at least some cryptocurrency in his/her personal cryptocurrency account/exchange platform. Ethereum (ETH) is preferred but it should be mentioned that similar method and system can be built on top of other cryptocurrency as well (CARDANO, SOLANA etc.) and a person skilled in the art would be able to use the method and system with any suitable cryptocurrency. The investor can also convert any cryptocurrency to ETH or if he/she does not have any cryptocurrency then he/she can easily buy it. If the investor does not have a personal cryptocurrency account/exchange platform, then he/she needs to register an account (preferably MetaMask) and then buy Ethereum (ETH) with the EUR/USD or any other acceptable currency.

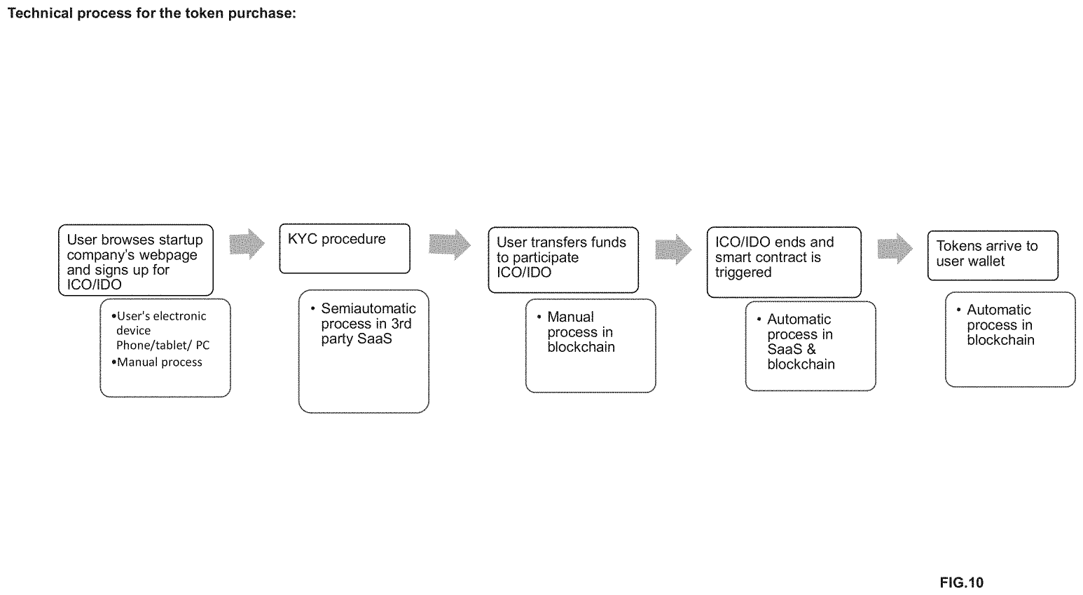

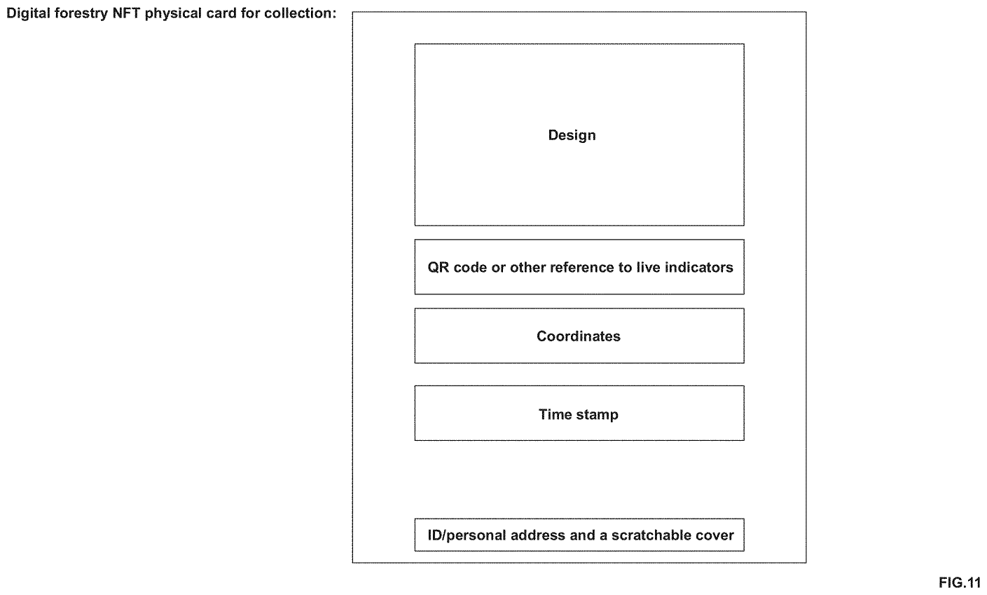

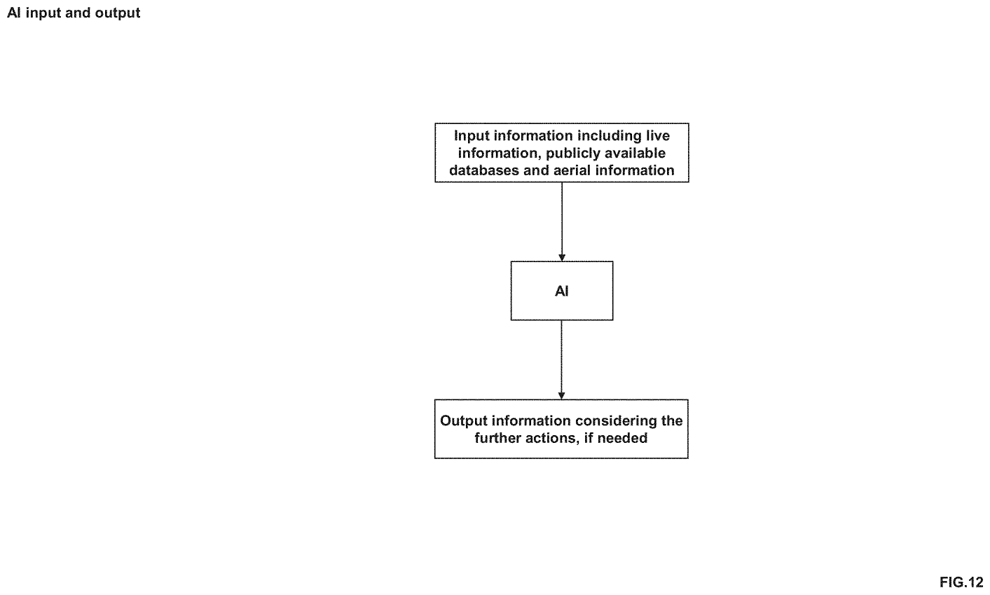

Now, to buy utility tokens (preferred name FORE), the investor needs to have or open an account that allows to receive/transfer ETH based utility tokens (preferred MetaMask). Only after that, the investor can buy ETH standard utility tokens FORE from the startup company. After successful buy, the investor has x number of utility tokens FORE in his/her preferred MetaMask account and company has X number of ETH. The startup company now converts the ETH to EUR or USD via any cryptocurrency exchange platform and invests it to the project. The investments may have a 50/50 logic—50% is to buy forests all over the world and 50% is used for the method and system buildup. Another preferred way is logic of 50/40/10 applies to each utility token that is purchased—50% of the amount goes to the purchase of forests, i.e. to the increase of the protected area, 40% to development activities, and 10% to the forest renewal reserve. As there naturally should be at least some returns of the investment, the investor gets a green utility i.e. opportunity to convert the tokens to limited collection of NFTs or plant trees etc. with the very same tokens. The tokens may have a hard cap which means that there will be strict limit on the number of FORE tokens that could ever exist and it is encoded in FORE's source code. Technical process for the token purchase is described in the FIG. 10.

In an alternative embodiment some of the processes or at least some parts of it may be automated by other service provider to make it more convenient for the investor.

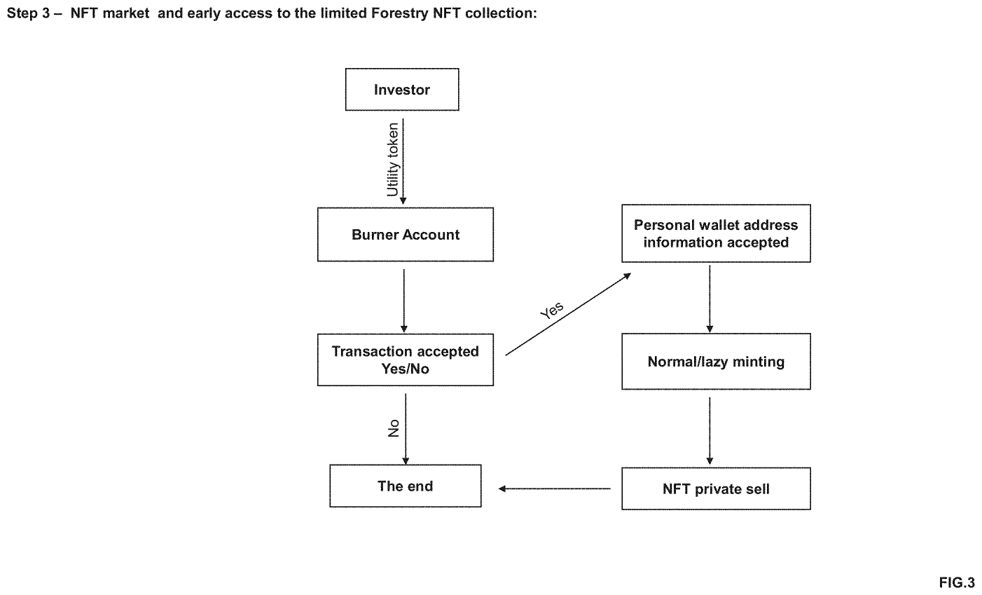

Step 3: Limited NFT collection (FIG. 3). Before starting step 3, it is necessary that FORE tokens worth of certain predetermined amount is sold in step 2. Step 3 is exclusively for the investors who participated in the ICO/IDO and bought at least some sum of FORE tokens. Based on the 50/50 example, half of the predetermined amount is invested to the forests and acquire the forest. The key feature here is that the acquired forest will not be clearcut which is the guarantee of the project. Acquiring here means that the owner will keep the rights to use the forest as long as not making such changes that the carbon sink value of the forest would decrease. The other part of the investment 50% moves directly to the research and development, so we can proceed with steps 3-5. Another preferred way is logic of 50/40/10-50% of the amount goes to the purchase of forests, i.e. to the increase of the protected area, 40% to development activities, and 10% to the forest renewal reserve. We will get also notary public agreement that certifies our intention to restore forest habitat and not use any action to damage the forest. The damage at this stage can be measured as lowered carbon sink value due to lower carbon dioxide absorption if for example growth of timber is lower than cut of timber. The startup company is allowed to use only scientifically approved measures to improve the quality of the forests so there is higher emission of oxygen and higher absorption of carbon dioxide. Now, if we know the basics, we can start to build the limited NFT collection. At this stage every investor has X number of FORE utility tokens. The company allows on their webpage to transfer X sum of FORE utility tokens to the burner account. “Burning” a cryptocurrency refers to the act of sending a token to an account that can only receive them. The act of burning effectively removes tokens from the available supply, which decreases the number in circulation. The burner account is also useful for getting the personal wallet address from the investor. If there is correct number of FORE utility tokens transferred from the investor account to the burner account, then the system automatically approves the transaction, if not, the investor has some time to correct the amount. The logic is here that everything that will be transferred to the burner account will be deleted forever and it is not possible to transfer the amount back to the investor. When everything is correct, the predefined amount of FORE tokens will be deleted and at the very same time the account number from where the transfer was made is saved. The same saved account number is now automatically sent to NFT platform. The NFT platform makes a private sale. It could be ordinary minting process or lazy minting, either way the logic is that the investor may need to pay extra only the minting and/or transferring costs of the NFT but the NFT itself is already prepaid with the FORE tokens. Now the system is randomly selecting the NFT that corresponds to the exact forest land plot that has been bought in the step 2. To be more precise, the NFT corresponds to exact geographical location where the forest grows and has some indicator to highlight how it grows, what actions have been done (tree planting etc.), how much carbon dioxide have been absorbed/oxygen released etc. In alternative embodiment the person or company that wants to participate to the project can choose a size and location of the forest plot based on the plot name/county/country etc provided by the startup company.

In another alternative embodiment the startup would buy the tokens based on the monetary amount the person or company that wants to participate would like to spend and the person or company would reimburse the startup. Once the transaction is completed, i.e. the startup company will mail a unique physical card i.e. physical copy of the digital NFT certificate (in a form of printout) with a QR code (FIG. 11) to the participant and leave the personal crypto address covered by for example a scratchable cover. There is on the card a private address where this NFT locates and the participant can use it later if they want to transfer the asset or they can just sell the card itself if the layer is still not removed.

Thus, basically, the NFT will be like a virtual forest plot that corresponds to unique location that is backed up by the real forest that will not be clearcut for at least a predetermined period of time. In the alternative embodiment, it could be also considered as a physical presentable/printable forest card that is linked to the non-fungible virtual asset (like a unique baseball card) that has special design, QR code/reference to live indicators, coordinates, time stamp, ID/personal address and a scratchable cover etc. linked with the startup company's website via the server that tracks all the live information/indicators (FIG. 11) and the environmental value is based on the length of the time period the forest has been managed to preserve its carbon sink value and/or has not been clearcut. Therefore, early investors can buy the best NFTs possible.

Now, when the random or preferred selection is made, the NFT will be transferred to investor's account, but the investor needs to have NFT platform account so, he/she can see the NFT. Therefore, it is preferred that the investor has a MetaMask and OpenSea (or an equivalent) account to have the full user experience and smooth transactions. At this stage the step 3 is completed. In an alternative embodiment some of the processes may be automated by other service provider to make it more convenient for the investor.

In an another alternative embodiment the investor can use only the physical and presentable card and still see all the necessary information when scanning the code by his/her personal device.

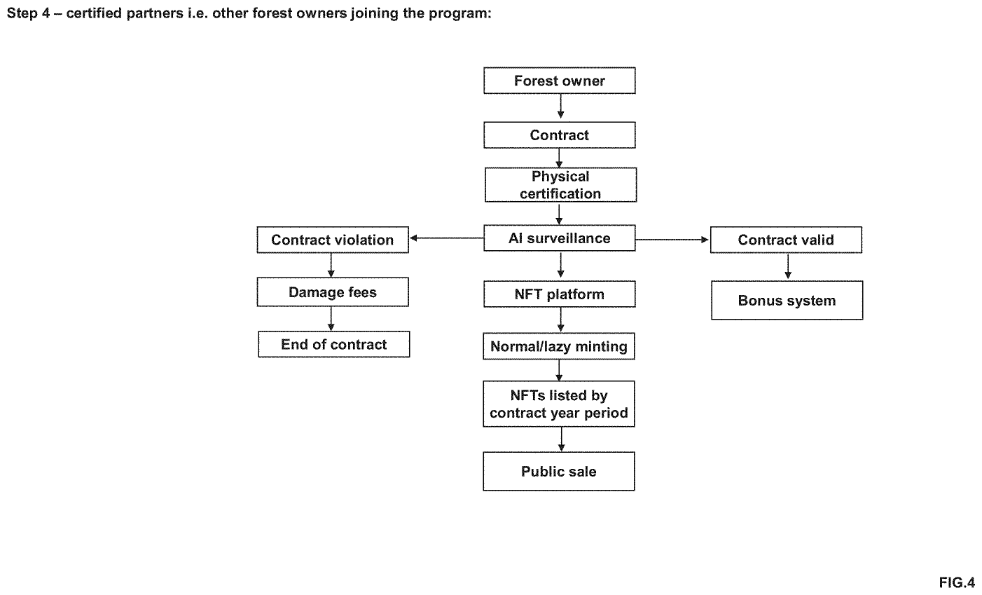

Step 4: In this step certified partners i.e., other forest owners are joining the platform (FIG. 4.). Forest owner will make a contract with the startup company. The contract highlights the length of the promise not to deforest nor clearcut the greenest asset on the planet Earth by the years counted for example as: 10 years, 20 years, 50 years, 100 years etc. After the contract execution the startup company provides EVERFORE physical certification to the partner. This physical certification is a certification to the third party partner to show that he/she manages the forest by the guidebook and that there is at least one digital NFT certificate for an end-user (i.e participant of to the cryptoproject). There will be also a damage fee for the violation of the contract and even possible termination of the contract between the third party and the startup company. There could be some bonus systems to the owners that have managed the forest on the best possible ways/or have planted predetermined number of new trees. Also, the bonus system may apply if the forest owner follows the startup company's guidelines, made with cooperation together the universities and scientists.

The management of the forest is followed by the smart AI system to monitor any breach of the contract—computer algorithm analysis aerial photographing, updated forest registers, maps, forest management plans are used to provide a risk index. If the risk index is more than 50% for a predetermined period of time, then the ground supervision will follow. The system will also take into account natural catastrophes, e.g., storm destroying the forest. After the successful contract, there will be minted NFT(s) based on the contract years. Each NFT carries an environmental value which is based on number of years the corresponding forest is expected not to be clearcut (expected number is based on the corresponding contract), and the age, location and area of the forest plot and the NFT with environmental value is listed on the NFT marketplace. In an alternative embodiment trading of the NFTs will be based on exchanging/trading the unique physical cards that correspond with each digital NFT certificate.

Every forest plot has different ecological and recreational value. It needs to be understood that values of not to clearcut nor deforestation can be much higher than the value of land and trees. The value that is related to the forest is a combination of its carbon sink value, its ecological value (more ecological niches for animals and plants) and its recreational value. This combination of values is reflected by the environmental value attached to the NFT and indicated in the physical or digital individual certificate. The environmental value of the forest changes over time and it is a priceless value that cannot be predicted at this time. The NFTs are listed in open market and can be paid by ETH. In essence the ETH can be converted directly to USD, EUR or other currency. In one embodiment at least 50% of the NFT price will then be transferred directly to the forest owner or allocated to annual payments as long the contract is in good standing. Other half of the ETH is used to development, research and company costs. This system thus provides real income to the forest owner without clearcutting the forest. In essence the forest owner in this system needs to enter a contract not to clearcut certain forest area and follow the green guidebook, Through the NFT the forest owner gets alternative income.

In alternative embodiment it can be also paid with FORE utility token or with combination of FORE utility token and ETH. Furthermore, the longer period the NFT have been existing, the more valuable it can be because the oxygen and carbon dioxide levels have indicator history. Therefore, the limited collection of NFTs in step 3 may be considered as the highest value non-fungible digital asset.

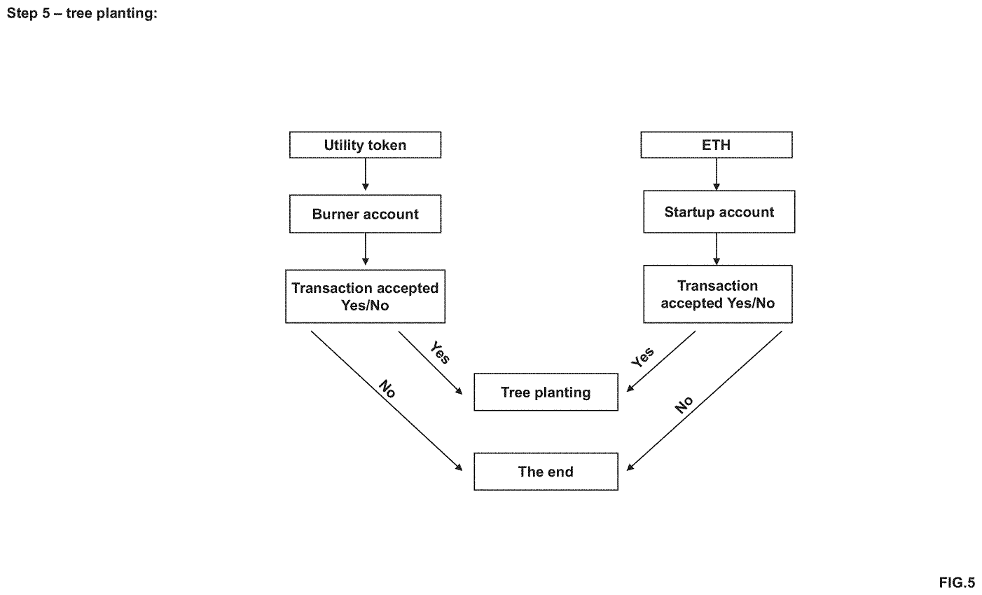

Step 5: Tree planting (FIG. 5). The tree planting option is open both to the FORE utility token owners and regular ETH owners. When the investor has the FORE tokens, they again have an opportunity to transfer as step 3 the amount of X to the burner account, the logic here is that this time the amount is another sum preferably a lot less and if the amount requirement is completed, the FORE tokens will be erased, and a new number of trees will be planted to absorb even more carbon dioxide and release more oxygen. It is also available option to transfer a required amount of ETH to the startup account and if the amount requirement is completed a new number of trees will be planted to again absorb carbon dioxide and release oxygen. Also, it may be possible to pay both ETH and Fore utility token to plant a tree.

In an alternative embodiment the startup would buy the tokens, plant trees, make the burning process and send the invoice to the client.

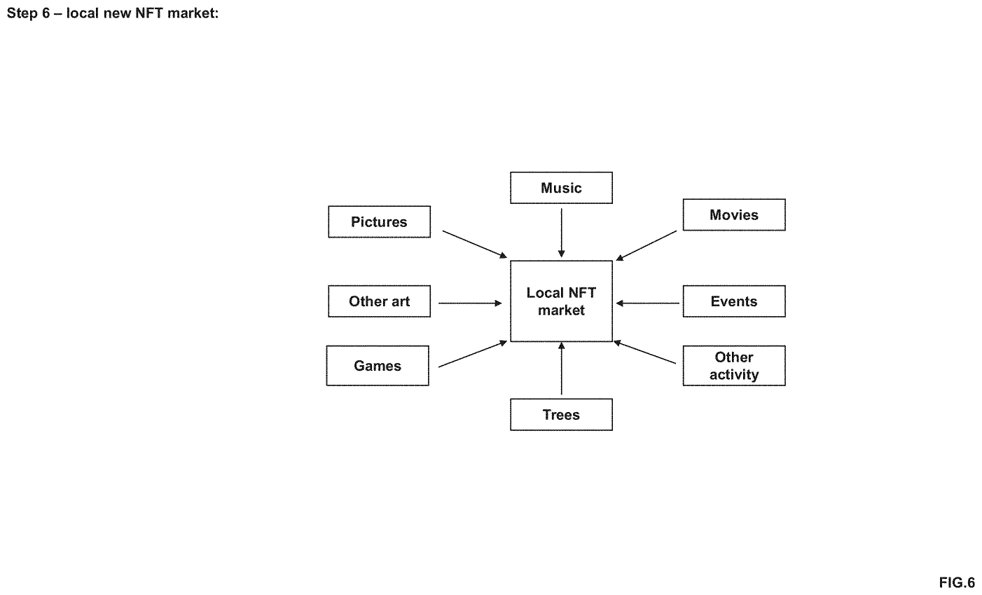

Step 6: Local new NFT market (FIG. 6). When all the previous steps have been successful, there is an option to open completely new local marketplace for NFTs. It may involve user friendly interface so the investor can buy with ETH a new kind of NFTs. This time it is fully open to all users. In alternative embodiment at least some sum may be paid with FORE or with combination of ETH and FORE utility token. The logic here is that the company has its own marketplace for the NFTs and the forest related non-fungible digital assets may be countless: to mention some, NFTs could be paintings, pictures, music, movies, documentaries, articles, books, songs, poems, any kind of art, events, games, rare trees etc. Each NFT is backed up with a real forest that is under contract not to be clearcut. Thus, when an NFT being for example a painting is sold, the ETH is convertible to USD, EUR or other currently and the income is preferably divided in 50/50 way where 50% is allocated to the forest owner having the valid contract not to clearcut the forest and the other half is used to development, research and company costs or for the forest renewal reserve. In an alternative embodiment all or part of the forest related NFTs are listed in startup company's marketplace.

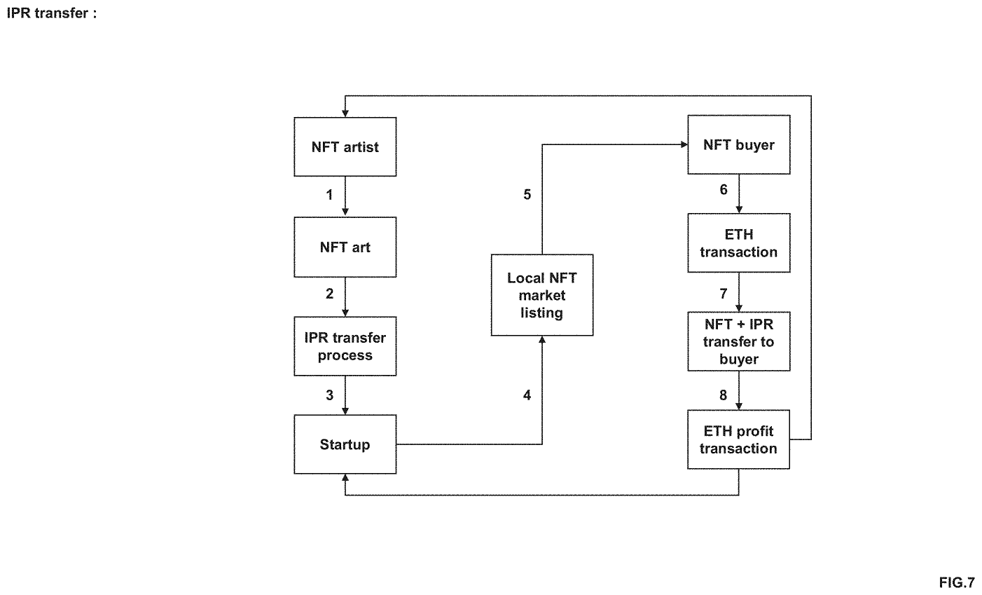

Authors of art do generally have certain intellectual property rights, most likely copyrights. In the system disclosed here, the authors of the forest related NFTs (music, pictures, paintings etc.) transfer their intellectual property to the maximum level allowable by the applicable laws to the company and the same rights will be transferred to a NFT buyer. This ascertains that the NFT buyer will fully own the forest related non-fungible digital asset (FIG. 7). Suitable contracts are prepared and provided preferably online between the parties (artist, company and buyer). This system creates a totally a new layer of NFTs and the purpose of this is to add value to the forest without having a need to deforest nor clearcut the greenest assets on the planet Earth.

What is claimed is:

1. A cryptocurrency based platform for supporting sustainable forest management, the platform comprising:
a multitude of non-fungible tokens (NFTs), wherein each NFT corresponds to an individual or shared forest plot, said forest plot being subject to a binding agreement executed in exchange of issuing the NFT;
each issued NFT having a defined environmental value determined by at least a carbon sink value of the forest plot and a period of time since the NFT was issued which time period corresponds to time the forest plot has been subject to the no clearcut contract; and
wherein
each issued NFT corresponds to a tradeable digital or physical NFT certificate having a scannable code that comprises information of the forest plot and the environmental value of the NFT.

2. The cryptocurrency based platform of claim 1, wherein changes in the information and environmental value of the NFT can be followed live by scanning the QR code of the tradable and/or presentable digital and physical card.

3. The cryptocurrency based platform of claim 1, wherein changes in the information and environmental value of the NFT are calculated by AI based on information provided from the forest plot by real measurements of physical measured in the forest plot or one or more similar plots, or by any estimations based on historical data from the forest plot or one or more similar plots.

4. The cryptocurrency based platform of claim 2, wherein the information of the NFT comprises photographs, videos, articles of the forest plot.

5. The cryptocurrency based platform of claim 1, wherein each forest plot corresponding to the NFTs is owned by one entity, wherein the entity is solely responsible of management of the forest plots based on the terms of the non clearcut agreement.
